(19) United States
(12) Patent Application Publication
(10) Pub. No.: US 2007/0294232 A1
(43) Pub. Date: Dec. 20, 2007

(54) System and method for analyzing patent value

(76) Inventors: Andrew Gibbs, Yuba City, CA (US); Stephanie Gibbs, Yuba City, CA (US)

Correspondence Address: MAIER & MAIER, PLLC, 1000 DUKE STREET, ALEXANDRIA, VA, 22314, US

(21) Appl. No.: 11/812,135

(22) Filed: Jun. 15, 2007

Related U.S. Application Data
(60) Provisional application No. 60/813,707, filed on Jun. 15, 2006.

(51) Int. Cl. G06F 17/30

(52) U.S. Cl. 707/3; 707/5; 707/1

(57) ABSTRACT

At least one exemplary embodiment discloses a system, computer program product and method for evaluating the value of a legal document such as a patent-related document. In accordance with at least one exemplary embodiment, a Latent Semantic Analysis (“LSA’) search engine can search a database of patent-related documents to identify an “N” number of patent-related documents deemed thereby as relevant to a target document and indices of the target patent-related document can be compared and scored against the indices of the relevant identified patent-related documents. At least one exemplary embodiment evaluates a plurality of indices of patent-related document value using legal, commercial and/or technological factors.

### PRIORITY

This application claims priority under 35 U.S.C. 119(e) to U.S. Provisional Application No. 60/813,707, filed Jun. 15, 2006, the disclosure of which is incorporated by reference herein in its entirety.

### FIELD

This invention relates to statistical analysis and computer modeling of various indicators of the legal, commercial and technological quality of a patent document as would be useful and meaningful to, inter alia, patent attorneys, intellectual property managers, inventors, financial professionals and professionals who use patent analysis in support of business, financial and legal decisions.

### BACKGROUND

Professionals in the intellectual property community have long pursued a reliable method for determining the value of a patent. In many cases, these methods produce a statistical probability of a particular valuation index of a patent. For example, various studies have been published that demonstrate regression models that predict the probability of a patent being litigated based on the number of forward citations occurring within the first three years after issuance such as the studies by Jean O. Lanjouw & Mark Schankerman entitled “Stylized Facts of Patent Litigation: Value, Scope and Ownership” and in “Characteristics of Patent Litigation: A Window on Competition.”

Other studies, such as “An analysis of the source of EPO citations: applicant vs. patent examiner citations” by Criscuolo, Geuna & Verspagen and “What Do Patent Indicators Really Measure? A Structural Test of ‘Novelty’ and “Inventive Step’ as Determinants of Patent Profitability,” show correlation between the technology value of a patent, the number of non-patent references cited by the inventors and the number of inventors listed on the patent.

The body of art related to the statistical evaluation of large-scale patent data dates back to the time period encompassing the 1960s through 1980s (and earlier), for instance, “Market value, R&D, and patents” by Grilliches (1981) and “Statistics of European patents on legal status and granting data” by Van der Drift (1989).

Further, some valuation tools, such as the Ocean Tomo Patent Ratings Intellectual Property Quotient (“IPQ”) (available at www.patentratings.com) strive to produce a single score based on a computer-automated evaluation system. Also, U.S. Pat. No. 6,556,992 (Barney et al.), which Ocean Tomo is the exclusive licensee of, teaches a statistical patent rating method and system for independently assessing the relative breadth, defensibility and commercial relevance of individual patent assets and other intangible intellectual property assets. Moreover, US Patent Publication No. 2004/0010393 (Barney) teaches a method and system for valuing patent assets based on statistical survival analysis. An estimated value probability distribution curve is calculated for an identified group of patent assets using statistical analysis of PTO maintenance fee records. Expected valuations for individual patent assets are calculated based on the value distribution curve and a comparative ranking or rating of individual patent assets relative to other patents in the group of identified patents.

The single “score” created in the above-identified background methods and systems of applied statistical computer modeling for patent analysis do not necessarily take into account many of the real world variables of patent valuation and can rely on a perspective for patent valuing that may be different from what a customer would view as important for determining patent value. For instance, a calculation providing a high score (and, thus, high value) for the commercial potential (e.g., licensing royalty potential) for a patent may have failed to consider the poor legal value of the same patent because it has a higher probability of invalidity if a targeted licensee opts not to take a license, but rather initiates litigation.

Still other services, such as those offered by the Metrics Group (see www.metricsgroup.com), 3i Analytics (see patentmaps.com) and Taeus (see www.taeus.com), combine the use of proprietary in-house analytics software with intellectual property consulting services provided by subject matter experts and generate patent value reports that attempt to establish valuation data points for a patent.

There is not a lack of attempts or approaches by patent and intellectual property professionals to devise systems and methods that assist industry professionals in determining a realistic value for a patent. One more example is www.patentvaluepredictor.com that employs an algorithm that computes the economic value of a market protected by a patent and the economic value of that patent by comparative analysis against the US Gross Domestic Product (“GDP”).

### SUMMARY

An embodiment of the present invention discloses a system and method for indexing a target patent document including a network accessible to one or more clients and at least one database, populated by a plurality of entries for a plurality of patent documents, on the network. An embodiment can also include one or more servers on the network and operatively interfaced with a database(s) where the one or more servers can include all or part of a semantic search module. The semantic search module can be configured to run a search query against the plurality of entries populating the database(s) and configured to identify a comparative collection comprised of a defined number of patent documents identified by semantic relevancy to the search query.

Yet another embodiment of the present invention discloses a system and method for evaluating a patent document that can include semantically applying a search query corresponding to a portion of a target patent document to one or more databases populated by a plurality of patent documents. Thus, a comparative collection of patent documents can be identified by semantic relevancy to the search query and the patent documents of the comparative collection can be retrieved from the one or more databases. Moreover, the target patent document can be evaluated by using one or more indicators where evaluating can further include comparing the target patent to the comparative collection.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a computer system.

FIG. 2 is an exemplary flowchart showing an embodiment for analyzing the value of a patent document.

FIG. 3 is an exemplary flowchart showing an ecommerce system and method.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

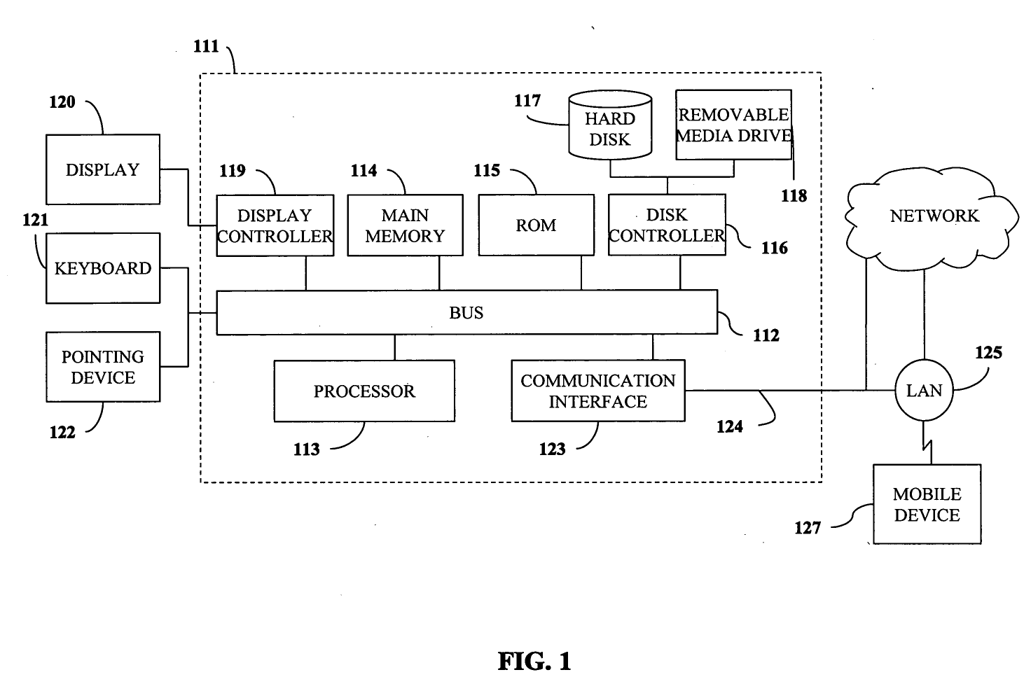

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, Oracle, SQL Server, My SQL, ACCESS, etc.), an object-oriented database management system (ODBMS), a file system or another conventional database package as a few non-limiting examples. The databases can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

At least one exemplary embodiment can provide for a system and method that evaluates a plurality of indices of patent and patent application value using legal, commercial and/or technological attributes. The evaluation can make use of a Latent Semantic Analysis (“LSA’) search engine to identify an “N” number of patent publications deemed thereby as the most closely related to a target patent document and the indices of the target patent document can be comparatively scored against the indices of the most closely related patent publications found.

In at least one exemplary embodiment, the LSA is applied to a document collection that can be a data corpus comprised of a large number of granted patents and/or published patent applications (i.e. patent publications). In other exemplary embodiments, the data corpus can be comprised of other patent documents, invention disclosures, defensive technology disclosures, technical articles, papers and/or dissertations or any other large collection of technical and/or legal documents known to one having ordinary skill in the art.

In at least one exemplary embodiment, a natural language search query can be submitted via a LSA search engine where the natural language search query is a portion of the text/language extracted from a target patent document and LSA can apply the query to a large collection of patent documents contained in a database. The first “N” number of patent publications that are deemed most closely related to the target patent document can be determined by the relevancy ranking capability of the LSA search technology and can be compiled as a comparative collection.

A LSA determination of which patent documents in a database are most closely related to a target patent document based on selecting a portion of the text of the target patent document for use as a search query may approach or reflect human knowledge in making the same determination. For example, a LSA search engine may identify many patent publications already listed as cited references on target granted patents, which would serve as evidence that the LSA determinations overlaps human determinations as LSA has been known to have overlapping scores as compared to humans on standard vocabulary and subject matter tests. LSA has also been known to mimic human word sorting and category judgments, simulate word-word and passage-word lexical printing data and can accurately estimate passage coherence and thus may be able to estimate the quality and quantity of knowledge contained in patent documents.

Since the comparative collection of patent documents as identified by LSA can define a coherent technological space or protected commercial market, subsequent analysis of the target patent document against the documents of the comparative collection may provide a truer evaluation of the real legal, commercial and technological factors that can comprise the value of a target patent document then might be obtained by some background system and methods. As opposed to some background system and methods for patent valuation that present a single conclusory score or value, exemplary embodiments of the present invention can present multiple independent analyses of legal, commercial and/or technological attributes of a target patent document. The multiple analyses of different types of attributes may reflect real world factors that other background systems and methods may not have accounted for and may decrease the chance that the evaluation is limited to a single party's perspective.

As one non-limiting example, a patent owner asserting that a party infringes its patent may consider a commercial value (e.g., licensing revenue potential therefrom) as a key valuation metric that can support a decision by management to pursue the investment in infringement litigation. On the other hand, the party that faces the litigation of threat thereof, may consider the identification of prior art that may invalidate the patent (i.e. a legal factor) as the key valuation metric or most important factor to be considered in valuing the asserted patent. Thus, a single score or value may fail to analyze or at least deliver to each of the above-identified parties the decision-support information that a user may deem necessary to understand the value of a patent document from their respective points of view. Overall, a single score or value may not support the various technological, commercial or legal strategies that can be encountered (sometime routinely) in the real business world.

Embodiments of the present invention can apply a statistical approach that may support multiple views of patent document value and increase the use of such an evaluation for supporting real world decision-making because multiple indicia of legal, commercial and/or technological value for a patent document can be combined into a single report. The presentation of discrete indices and indices by category can allow the user of a report to draw their own conclusions by weighting the indices presented and determining which scores, if any, on each of the indicia are relevant or important to the user's decision or intended purpose for using the report.

In at least one embodiment, a LSA linguistic search method can determine and identify the most closely related patents and patent applications based on a semantic analysis of a corpus data of patent documents. One or more regression models, statistical patent data analysis methods and/or technology adoption/diffusion curves can be used to measure the target patent document against the “N” number of most closely related patent documents so that a broader picture of the components that contribute to the value of the target patent document can be revealed. Various indices of a target patent document may be compared (using such models, methods, curves and the like known to one having ordinary skill in the art) with a “N” number of closely related patent publications contained in the comparative collection identified by the LSA search.

The value of “N” for the “N” number of most closely related patent publications characterizing the comparative collection can be any quantity that adequately characterizes a technology or market segment. Particularly, about 100 closely related patent documents may comprise a satisfactory comparative collection for many technology areas, while a more extensive collection, for example, of about 1,000 or more patent documents can be suitable to define crowded or highly competitive technology areas. Crowded or highly competitive technology areas can themselves be characterized or identified by a high volume of patent publications in the area.

Exemplary embodiments can provide for the analysis of various independent indicators of the value of a target patent document so that the analysis may allow different parties to select different indices which support their independent and different business and/or legal strategies. The various factors to be analyzed may include, but are not so limited to, one or more of: (1) enforceability; (2) total relevancy strength; (3) novelty; (4) claim scope breadth; (5) validity confidence (e.g., based on occurrence of prior art that was not cited by the applicant or examiner or concurrent art that was not cited by the applicant or examiner); (6) sustainability in opposition; (7) litigation avoidance; (8) forward citation value contribution; (9) backward citation value contribution; (10) enforcement licensing potential; (11) partnering licensing potential; (12) crowdedness (showing, e.g., potential licensees); (13) divestiture licensing premium (patent grouping); (14) patent group competitive position; (15) in-license opportunity; (16) technology advancement; (17) technical sophistication; (18) combinatorial accession; (19) technology cogency; (20) technology adoption diffusion “S” curves; and (21) technology development.

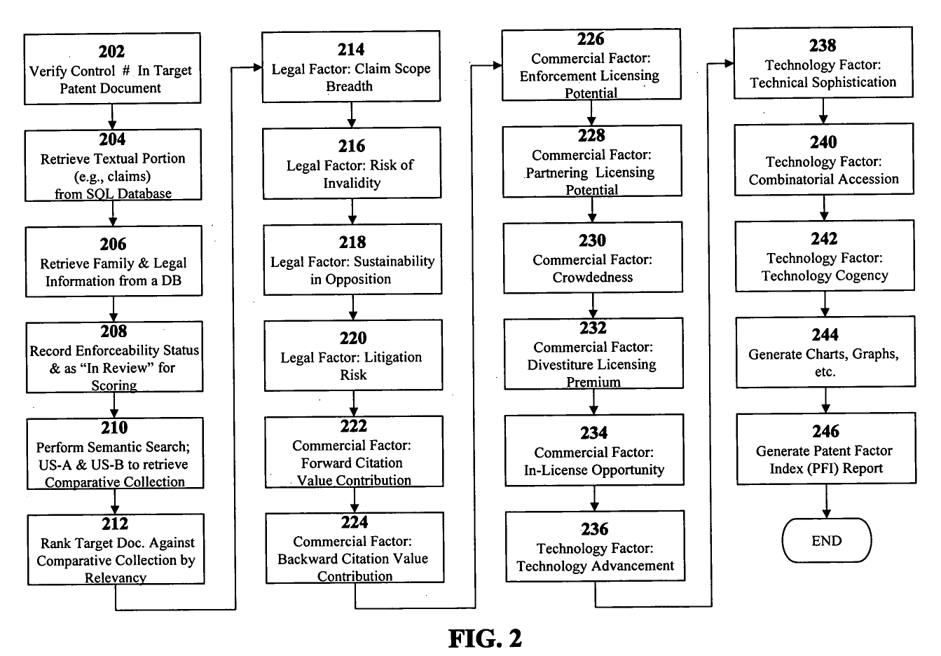

As shown in the flowchart of FIG. 2, at least one exemplary embodiment can generate a patent factor index (“PFI”) report based on scoring one or more indices that can be categorized as legal factors, commercial factors and/or technology factors. At step 202, a patent number or a patent publication number can be verified after it is entered by a user. Alternatively, an application, serial or any other control number known to one having ordinary skill in the art can be used to identify a patent document stored within a database such as a structured database, which can be a relational database. At step 204, a portion of the text of the target patent document such as the claims can be retrieved using structured query language (“SQL”) from a database. Optionally, at step 206, patent family and other legal information can be retrieved from a database such as the database, which can be accessed via the Internet, maintained by the European Patent Office (“EPO”) or any other databases maintained by any other foreign or domestic entities. For example, patent family and legal information can also be accessed through any number of commercial database providers such as Derwent, Westlaw and LexisNexis as a few non-limiting examples. At step 208, the enforceability status of the patent document can be determined, for instance, by retrieving such data from a database such as any of the above-described databases that contain suitable enforceability data on the target data and can be recorded so as to form a portion of any report generated in this or any other step(s). Also, at step 208, a message can be displayed to a user that the target patent document is “in review” and the like indicating that a patent factor analysis is or will shortly thereafter be in the state of processing.

At step 210, a semantic search such as a Latent Semantic Analysis (“LSA”), which is also sometimes called Latent Semantic Indexing (“LSI”) when applied to information retrieval (“IR”), can be ran against a database containing a plurality of corpus data, for instance, a plurality of patent documents (e.g., published patents and patent applications) using a portion of the text of the target patent document (e.g., the claims retrieved in step 204) and can identify an “N” number of patent documents deemed closely related. For example, a criteria can be instated that has “N” equal one hundred (100) as one non-limiting example so that 100 of the most closely related patent documents as identified by the LSA can be retrieved. Also, at step 210, the patent documents deemed closely related can be themselves and metric data (such as number of forward and backward citations, number of inventors, priority dates, etc.), like the exemplary metrics described below and other metric data that will also be appreciated by one having ordinary skill in the art, can also be stored in a storage medium along with or separately from the patent documents.

Still referring to the flowchart of FIG. 2, the patent documents stored can be relevancy ranked using the relevancy ranking functionality that may be employed as part of the LSA in step 212. The target document itself can be ranked within/against the comparative collection (i.e. the “N” number of patent documents retrieved in step 210). A score can be determined and stored for the target patent document rank in comparison to the comparative collection where, for example, a target patent document that ranks as the most relevant document when compared to the comparative collection achieves the greatest score.

Turning to step 214 of FIG. 2, which can determine one of numerous factors that can be categorized as legal, commercial and/or technology factors, claim scope breadth can be analyzed and scored. At step 214, in at least one exemplary embodiment, claim scope breadth (a legal factor) can be analyzed based on the relationship of the number of backward citations to claim scope breadth. For instance, patent publications containing a greater number of backward patent publication and non-patent literature citations can indicate claims of a narrower scope (i.e. containing more limitations). The target patent document can be analyzed by being compared to each of the “N” number of the most relevant patent documents as identified by performing a semantic search using selected text of the target patent document as a search query. Similar to other determinations described below, the comparison can be made by determining the average number of relevant backward citations on the “N” number of the most closely related patent documents as well as other statistical data such as the minimum and maximum relevant forwards citations within the comparative collection and a score can be assigned to the target patent document (based on any mathematical formula known to one having ordinary skill in the art), for example, reflecting the target patent document's position with the comparative collection of the “N” number of closely related patent documents. Thus, for example, if the number of backward citations on the target patent document is less than the average for the comparative collection than a greater score on the claim scope breadth factor can be calculated.

Referring to another of the various indices that can be put into numerous categories including, but not limited to, legal value, commercial value and/or technological value. In at least one exemplary embodiment, a method and system for assessing the risk of invalidity (a legal factor) of a granted patent can be determined and reported. For example, at step 216, a score for the risk of invalidity can be calculated based on prior art and/or concurrent art. If the analysis is to, at least in part, evaluate prior art and/or concurrent art (which may have not been cited by the applicant or the examiner), the search can be limited to patent documents meeting such criteria as: (1) patent documents filed on a date earlier than the effective or actual filing date of the target patent; and (2) have a relevancy ranking score that is higher (indicating greater relevance) than the target patent. Patent documents found that match the above criteria and that were not cited by the applicant or examiner have an increased probability of being un-cited relevant prior art and/or relevant copending art (i.e. filed earlier, but pending at the USPTO during the same time as the target patent) that could potentially be used to invalidate the target patent. In at least one exemplary embodiment of step 216, a list, which may be combined into a part of the report, can be created listing the patent documents that satisfy the above criteria and that were not cited by the applicant or examiner. Also, at step 116, a score (or two separate scores referring to prior art and concurrent art respectively) can be generated based on the number of such prior and/or copending art references where the lower the number of such references can be given a greater score.

At step 218 of FIG. 2, in another exemplary embodiment, sustainability in opposition (a legal factor) can be analyzed and scored. The number of inventors on a patent document can indicate or correlate to the likelihood that a patent or patent application will survive opposition—the fewer inventors named the more likely a patent is to survive opposition. Therefore, to determine sustainability in opposition in step 218, the number of inventors named on the target patent document can be compared to the number of inventors on each of the “N” number of most relevant patent publications as identified by performing a semantic search using selected text of the target patent document as a search query. Similar to other determinations, the comparison can be made by determining the average number of inventors on the “N” number of the most closely related patent publications as well as other statistical data such as the minimum and maximum number of inventors named within the comparative collection and a score can be assigned to the target patent document (based on any mathematical formula known to one having ordinary skill in the art), for example, reflecting the target patent document's position with the comparative collection of the “N” number of closely related patent publications.

Further, at step 220, in yet another exemplary embodiment, a method and system for analyzing and scoring the probability of a patent being litigated (i.e. litigation risk, a legal factor) can be employed as another PFI. The probability of a patent being litigated can be determined by analyzing the number of forward citations within, for example, the first three years after issuance and statistically compared to the number of forward citations during this time period for the “N” number of most relevant patents as identified by performing a semantic search using selected text (such as the patent claims) of the target patent as a search query.

Yet another exemplary embodiment may include a method and system for analyzing and scoring litigation avoidance. As stated above, when compared to closely related patents, a target patent having relatively more forward citations within the first three years of issuance is more likely to be the subject of future litigation. Thus, the converse may also be true and a target patent have less forward citations as compared to the comparative collection will have a lesser likelihood of being the subject of future litigation.

To determine the probability/likelihood of being the subject of litigation or, conversely, avoidance thereof, the number of forward citations within the first three years of issuance referencing the target patent can be compared to the number of forward citations referencing each of the “N” number of most relevant patents as identified by performing a semantic search using selected text of the target patent as a search query. Similar to other score determinations, the comparison can be made by determining the average number of relevant forward citations on the “N” number of the most closely related patents as well as other statistical data such as the minimum and maximum relevant forwards citations within the comparative collection and a score can be assigned to the target patent (based on any mathematical formula known to one having ordinary skill in the art), for example, reflecting the target patent's position with the comparative collection of the “N” number of closely related patents.

Referring now to the commercial factors of the flowchart of FIG. 2, in at least one other embodiment, the total number of forward citation can indicate a higher value for a target patent document and this analysis may be called a “forward citation value contribution.” Statistically, a greater number of forward citations can indicate a greater patent value as compared to the “N” number of most closely related patent publications as identified by performing a semantic search using a selected portion of text from the target patent document as a search query applied to a data corpus of patent publications. The total number of forward citations can correspond to, for example, more licensing opportunities generally. Thus, at step 222, a score can be calculated based on the “forward citation value contribution” as compared to any statistical determination of the forward citation value of the comparative collection.

Likewise, at step 224, in at least one embodiment, the total number of backward citations (a commercial factor) can be analyzed and scored, which may indicate a larger potential market, which also increases patent value and may be called the “backward citation value contribution.” Although backward citations may be a less reliable indicator or contributor to patent value than forward citations, nevertheless, they may still serve as an important index of the potential commercial value of the target patent document. Like the determinations above, the total backward citations of the target patent document are statistically compared against the number of backward citations for the “N” number of most relevant patent publications as identified by performing a semantic search with a selected portion of text from the target patent document as a search query. In this exemplary analysis, the value of the backward citation contribution at step 224 to overall patent value can be balanced by a user against the negative correlation a greater number of backward citations may have when analyzing claim scope breadth at step 214, which can decrease the overall patent value. Conversely, a relatively lower number of backward citations can indicate greater claim scope breadth at step 214 as compared to the comparative collection, which can be balance against the same negative correlation such value has when determining patent value due to a larger potential market in the “backward citation value contribution” analysis of step 224.

Moreover, at step 226 of FIG. 2, in at least one other exemplary embodiment, enforcement licensing potential (a commercial factor) can be analyzed and a score calculated reflecting such potential. If the patent owner's business strategy is to license a target patent document to a relatively few larger companies who may dominate a particular market(s) where the target patent document may offer or is predicted to offer patent protection within the market, then an analysis at step 226 showing fewer parties in the market or technology field as may be shown by fewer total patent assignees (or applicants on many foreign patents) within the comparative collection can indicate a more favorable business environment to pursue, for example, greater revenues per license (and licensee). On the other hand, if the patent owner's business strategy calls for greater amount of licensing opportunities to relatively smaller companies (for example, a licensing model that may decrease the chance of a party subjecting the patent to future litigation), than identifying a greater number of assignees (or applicants on many foreign patents) can be a determination in step 226 having greater value. Thus, at step 226, exemplary embodiments of the present invention can be modeled to score the target patent document's enforcement licensing potential either higher based on fewer licensee candidates or to score higher based on a greater number of licensee candidates. Further, in exemplary embodiments of step 226, a list can be generated of the identified licensee candidates and can form a portion of a report generated.

Also, the number of assignees calculated at step 226 (or applicants on various foreign patent publications) can also indicate crowdedness in the market or field. Crowdedness may correspond to potential licensing opportunities. A greater number of assignee can indicate other indices of patent value such as increased research and development investments due to stronger activity in the particular market or technology area that the patent document corresponds to. Of course, this too can also be a positive indicator of licensing potential.

Further, at step 228, in at least one exemplary embodiment, partnering licensing potential (a commercial factor) can be analyzed and scored, which may be based upon determining cross-classification data. For example, a potential benefit of using a LSA search tool to identify the most closely related patent documents is that the search results can often contain patent documents that are related to the claimed invention of the target patent document, but that are classified by a patent office in classifications other than the classification(s) of the target patent document. Thus, the comparative collection resulting from a LSA search may disclose patent documents in analogous arts that inventions made, used or sold according thereto may or may not infringe a target patent. At step 228, a list of licensee candidates based on the inventor and/or assignee data contained within the comparative collection documents having non-obvious classification or, singly or alternatively, a list of non-obvious (i.e. different) classification themselves can be computed. Also, at step 228, a greater number of non-obvious classifications can be statistically computed (e.g., according to any mathematical computation known to one having ordinary skill in the art) to reflect a greater score corresponding to greater potential in non-obvious licensing opportunities. Presumably, licensing potential based upon non-obvious classifications is itself based upon invention activity in related markets protected by different patent classifications.

Yet further, at step 230, in at least one exemplary embodiment, crowdedness (a commercial factor) in the technology field (and also to fields related thereto) can be analyzed and a score computed based upon, for example, the total number of distinct assignees, inventors and/or applicants (e.g., for example applicants are not necessarily inventors in many foreign countries). The greater the number of, for instance, distinct assignees listed with the “N” number of most relevant patent publications retrieved can suggest that more research and development investment driven by higher activity in a particular market or markets. As stated before, this can also be probative of licensing opportunities as analyzed in step 222. At step 230, the number of distinct assignee can be retrieved for listing and/or a score computed corresponding to the number of distinct assignees as compared to the comparative collection.

Still further, at step 232, in at least one exemplary embodiment, divestiture licensing premium (a commercial factor) can be analyzed and scored based on a patent group determination. A greater amount of patent publications owned by a party as determined by retrieving assignee (or applicant) data and calculating the number of patents or patent publications within the “N” number of most closely related patent publications owned, for example, by an assignee can be indicative of broader market protection. A target patent document can be assigned a score based on whether the target patent document is one of a calculated number of patent documents listed within the “N” number of most closely related patent publications owned by the same party. Indeed, the target patent document can be seen as one exemplary patent document of a larger patent group. The score may have increased relevance to patent value, when the number of patent publications forming the patent group is compared to the number of third party patent groups and the number of patent documents within each group owned by a third party are determined and analyzed within the comparative collection. Also, at step 232, in at least one exemplary embodiment, patent group competitive position (a commercial factor) can be analyzed and scored. The competitive position is determined by analyzing the overall size of the target patent group as compared to the overall size of third party (e.g., competitor's) patent groups identified within the “N” number of most relevant patent publications.

Still referring to FIG. 2, in at least one exemplary embodiment, in-license opportunity (a commercial factor) can be analyzed and scored at step 234. For example, a company (or any other person or entity) may desire to add to or build a new patent portfolio through in-licensing. At step 234, the absolute or relative number of unassigned and still enforceable patents with the “N” number of most relevant patents as identified by an LSA search using a selected target patent(s) and a portion of the text thereof as a search query. A search based on, for example, the claims of the target patent can be representative of patents or patent publications (which may later become candidates for in-licensing) that the company may desire to establish a patent portfolio of or expand upon a patent portfolio having patents similarly relevant to the target patent. The “N” number of relevant candidate patents for in-licensing can be determined, analyzed and rated/scored. For instance, the greater the number of unassigned patents the greater the corresponding PFI score for the target patent on this category.

Referring now to the exemplary technology factors analyzed in the steps of FIG. 2, in at least one exemplary embodiment, the contribution a target patent document makes to technology advancement can be analyzed and scored at step 236. While all patents and patent publications presumably correspond to an advance in technology, some patent publications may represent only an incremental advancement in a particular technology, while other patent publications may represent a seminal technology that may possibly launch a new industry or take an existing industry in a new direction. The PFI score of step 236 can be based on whether the target patent document corresponds to an incremental or significant step over the technology disclosed by the “N” number of most closely related patent publications as identified by a LSA search. For example, the PFI score of step 236 can be based on the number of backward patent publications and non-patent literature citations where a lesser number of such citations correspond to a potentially higher technology advancement index. Also, the indication that a greater number of backward citations can have on claim scope (as separately analyzed at step 214) may be factored in and can be analyzed to determine whether a target patent has broader coverage in a stronger technology.

Also, at step 238, in at least one exemplary embodiment, technical sophistication (a technology factor) can be analyzed and scored. A greater number of forward citations to the target patent document as statistically compared to the “N” number of the most relevant patent publications as identified by a LSA search can indicate a greater level of technical sophistication. Similar to other score determinations, a comparison can be made by determining the average number of relevant forward citations to the “N” number of the most closely related patent publications as well as other statistical data such as the minimum and maximum relevant forwards citations within the comparative collection and a score can be assigned to the target patent document (based on any mathematical formula known to one having ordinary skill in the art), for example, reflecting the target patent document's position with the comparative collection of the “N” number of closely related patent publications.

Moreover, in at least one exemplary embodiment, combinatorial accession (a technology factor) can be analyzed and scored at step 240. A greater number of primary patent classifications present within the “N” number of most relevant patent publications as identified by an LSA search that differ from the target patent document's primary classifications, the greater the likelihood of increased diffusion of the core technology. As a technology is presumably adopted into products and services and as it is increasingly applied to new industries and markets, its value can increase substantially. The ability of LSA to identify analogous art or patent documents that teach the concepts of the target patent document when patent documents do not necessarily rely on the same lexicon (e.g., word choice and labels) as the target patent document as well as may not be classified similarly by a patent office can enable LSA to identify patent publications and underlying products, services and technologies from which the technology of the target patent document is related to (e.g., accedes from) in a broader sense. A broader adopted technology may correlate to the target patent document having a greater value.

Furthermore, in at least one exemplary embodiment, technology cogency can be analyzed and scored at step 242. The greater the number of inventors named on a target patent document when compared to the “N” number of most relevant patent publications as identified by a LSA search arguably indicates a stronger, more substantial and/or persistent technology and, thus, a more cogent technology. Remember, that greater amount of inventors also can indicate that the target patent document is less likely to survive opposition. Thus, a PFI report taking both indices into account may provide a user a more complete picture of the strengths and weaknesses of a target patent document because component scores can be listed and categorized differently within one or more reports.

Still referring to the flowchart of FIG. 2, once any or all of the legal, commercial and/or technological factors have been analyzed and/or scored, the respective scores can be recorded. Also, any other data such as data arranged in lists can be recorded. Optionally, the recorded data can also be used to generate any graphs and charts known to one having ordinary skill in the art at step 244. For example, in at least one exemplary embodiment, an Adoption Diffusion S-Curve may be generated. Because a LSA search can identify relevant patent publications that may have issued in different classifications from the target patent document, which can indicate diffusion of the core technology across various products, services and industry sectors. Exemplary embodiments may be configured to generate an Adoption Diffusion S-Curve in order to help a patent evaluator determine the age of the technology (as can be determined by the number of technology generations occurring since the filing date) and the relative position of dominance within the continuum of technology development over time as represented by the curve. It is known to those having ordinary skill in the art that patents typically applied for at the steepest transition between the “long flat tail” and the rapid rise of the curve can be of the greatest value. A time-dependent view as shown by an Adoption Diffusion S-Curve can increase a patent evaluator's understanding of the importance of a target patent document to the overall market development as defined by the “N” number of the most relevant patent documents identified by a LSA search using a portion of the text of a target patent document as a search query.

At step 246, or during any other step where data such as scores have been recorded, the data can be displayed to a user. For instance, at step 246, any and all scores, lists (including a list of the “N” of patent publications forming the comparative collection), relevancy ranks, graphs, charts and the like known to one having ordinary skill in the art that have be generated by at least one exemplary embodiment can be displayed. Further, at step 246, all scores, lists, relevancy ranks, graphs and charts can be contained within a document (or documents) such as a PDF document that can be called a PFI report. A user or users can use the data contained within the report to make decisions based on the results of the semantic and patent factor analyses ran for the target patent document.

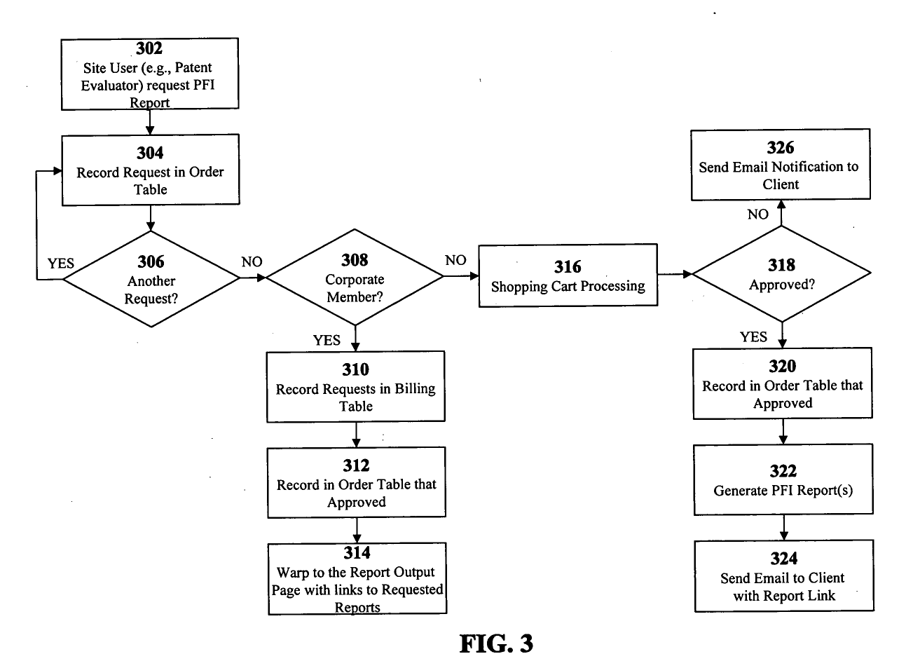

Referring now to the flowchart of FIG. 3, a method and ecommerce system for, inter alia, ordering, process a payment for, computing patent factor evaluation scores for a target patent document and delivering a report to a user/purchaser (e.g., patent evaluator) is disclosed in accordance with at least one exemplary embodiment of the present invention. One exemplary embodiment can be a web-based application where a user requests a patent factor index (PFI) report at step 302 through a webpage and at least one associated web-based application. The request can be effectuated by entering a control number for a patent document such as the patent number for an issued patent or the serial number for a pending application. At step 304, the request and associated control number can be recorded within a patent factor table and the user can be prompted to enter another request at step 306. If a user responds affirmatively to the prompt of step 306 (e.g., by selecting “yes” in response to the prompt), a user can be directed back to step 304 to enter another request by, for example, entering another control number of a patent document. This feedback loop can be repeated until a user has requested all patent factor reports for all patent publications and responds in the negative to the prompt of step 306 (e.g., by selecting “no” in response to the prompt).

Optionally, a second prompt can be configured to determine whether the user is a member such as a corporate member who has an account stored within the system in step 308. If a user responds affirmatively to the prompt of step 308, an exemplary embodiment can verify a user's account information upon entry and proceed to step 310. At step 310, the one or more requests can be recorded in a patent factor billing table. At step 312, the requests can be recorded in a patent factor order table and the status of the requests as approved can also be recorded. At step 314, a user can be displayed a report output page (e.g., onscreen through the same website and/or sent an email with report links) with links (e.g., hyperlinks) to the requested reports, which may have been processed according to at least one exemplary embodiment of the present invention such as the exemplary embodiments disclosed above in conjunction with FIG. 2. From step 314, a user can select, display and print reports corresponding to the requested patent documents in accordance with at least one exemplary embodiment of the present invention.

If a user responds in the negative to the prompt of step 308 or step 308 is omitted from at least one exemplary embodiment, then a user can be directed to shopping cart processing at step 316. At step 316, information such as payment information (such as method of payment and associated data as well as payment amount and the like) can be submitted. At step 318, the payment information, for example, credit card payment information can be either approved or denied. If denied, a user can be alerted at step 326 via an onscreen notification and/or email notification and the like known to one having ordinary skill in the art. If approved, an exemplary embodiment can proceed to step 320 where the requests and the status of approved therefore can be recorded in a patent factor table. At step 322, PFI reports can be generated according to at least one exemplary embodiment of the present invention such as those disclosed above in conjunction with FIG. 2. At step 324, a user can be displayed a report output page (e.g., onscreen through the same website and/or sent an email with report links) with links (e.g., hyperlinks) to the requested reports. From step 314, a user can select, display and print reports corresponding to the requested patent documents in accordance with at least one exemplary embodiment of the present invention.

As is readily apparent to one skilled in the art, exemplary embodiments of the present invention teach numerous technical, legal and commercial value indicators of patent value where part of the importance can be the ability to view the individual score, if any, for each patent factor index (“PFI”) and the process of correlating the various factors that may cause one score to increase while causing another score to decrease. Exemplary embodiments can make use of a linguistic analysis that can lead to the identification of the “N” number of most closely related patent publications based on LSA of text from a target patent document used as a search query upon a database containing an extensive collection of patent documents. The linguistic/semantic analysis can provide the ability for exemplary embodiments to qualitatively analyze legal, commercial and technological value of a patent document. This can be achieved by applying regression models, citation analysis and/or various other analyses against a target patent document, which can determine strengths and weaknesses as well as probabilistic outcomes relating to, for example, litigation, validity and commercialization opportunities as a few non-limiting examples as well as a various other indicators of a target patent document's value.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for indexing a target patent document, comprising:
a network accessible to one or more clients;
at least one database on the network, the at least one database populated by a plurality of entries for a plurality of patent documents; and
one or more servers having all or part of a semantic search module, the one or more servers being on the network and operatively interfaced with the at least one database, wherein the semantic search module is configured to run a search query against the plurality of entries populating the at least one database and configured to identify a comparative collection comprised of a defined number of the plurality of patent documents identified by semantic relevancy to the search query.

2. The system of claim 1, wherein at least a portion of the network comprises the Internet.

3. The system of claim 1, wherein the semantic search module is configured to generate the search query from a textual portion of a queried target patent document.

4. The system of claim 3, wherein the semantic search module is configured to generate the search query from the textual portion corresponding to one or more claims of the queried target patent document retrieved from the at least one database by a control number for the queried target patent document.

5. The system of claim 1, wherein the one or more servers further has all or part of a patent factor index module configured to evaluate one or more indices of patent value by comparing a target patent document to the comparative collection.

6. The system of claim 5, wherein the one or more indices include one or more legal factors.

7. The system of claim 5, wherein the one or more indices include one or more commercial factors.

8. The system of claim 5, wherein the one or more indices include one or more technology factors.

9. The system of claim 5, wherein the patent factor index module is configured to statistically compare and score the one or more indices of patent value.

10. The system of claim 5, where the patent factor index module is configured to generate a report.

11. A method for evaluating a patent document, comprising:
semantically applying a search query corresponding to a portion of a target patent document to one or more databases populated by a plurality of patent documents;
identifying a comparative collection of patent documents by semantic relevancy to the search query;
retrieving the patent documents of the comparative collection from the one or more databases; and
evaluating one or more indicators of target patent value, wherein evaluating includes comparing the target patent to the comparative collection.

12. The method of claim 11, wherein comparing the target patent to the comparative collection includes ranking the target patent within the comparative collection by semantic relevancy.

13. The method of claim 11, wherein evaluating one or more indicators of target patent value includes statistically comparing the target patent to the comparative collection.

14. The method of claim 13, further comprising:
scoring at least one of the one or more indicators of target patent value.

15. The method of claim 14, further comprising:
generating a report including one or more scores for the one or more indicators of target patent value.

16. The method of claim 11, wherein the portion of the target patent document includes one or more claims of the target patent document.

17. The method of claim 11, wherein the one or more indicators of target patent value include at least one legal factor.

18. The method of claim 11, wherein the one or more factors of target patent value include at least one commercial factor.

19. The method of claim 11, wherein the one or more factors of target patent value include at least one technology factor.
